(19) United States
(12) Patent Application Publication
(10) Pub. No.: US 2002/0084707 A1
(43) Pub. Date: Jul. 4, 2002

(54) Vibrating toothbrush

(76) Inventor: Man Chiu Tang, Kwai Chung (HK)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/026,444

(22) Filed: Dec. 27, 2001

Related U.S. Application Data
(60) Provisional application No. 60/258,358, filed on Dec. 28, 2000.

(51) Int. Cl. A61C 17/22; H02K 7/06

(52) U.S. Cl. 310/81; 15/22.1

(57) ABSTRACT

A vibrating toothbrush includes a power source with a charging coil or bobbin wrapped thereabout. The power source is attached to a motor that is directly and rotatably connected to a rotatable magnet. The rotatable magnet has a plurality of alternating pairs of magnetic poles and is adjacent a permanent magnet. The permanent magnet is disposed on a first end of a lever arm with a brush attached to the other end of the lever arm. The rotation of the motor causes the rotatable magnet to rotate. The alternating polarity of the magnetic poles on the rotating magnet results in the permanent magnet oscillating, which in turn oscillates the lever arm and vibrates the brush on the second end of the lever arm.

### BACKGROUND OF THE INVENTION

1. Field of the Invention

This invention relates to a vibrating toothbrush. In particular, this invention relates to a toothbrush that is vibrated by alternating pairs of magnetic poles that are rotated by a motor, the speed or frequency of the vibration being completely variable and based solely on the rotational speed of the motor.

2. Discussion of Related Art

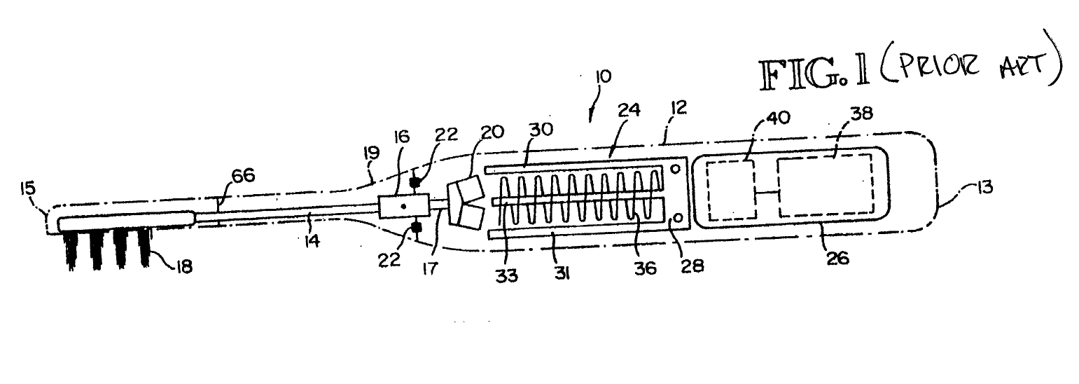

Toothbrushes that are vibrated using magnetic drivers are well known. For example, U.S. Pat. No. 5,189,751 to Giuliani et al. (Giuliani) discloses a vibrating toothbrush using a magnetic driver. As shown in FIG. 1, the toothbrush 10 includes a hollow case 12 having an elongated lever arm 14 mounted on a pivot member 16 which permits vibration of the lever arm 14 in vertical or horizontal, planes. The pivot member 16 is mounted to the case 12, and a spring element 22 is provided to bias the lever arm 14 in a central position.

A permanent magnet assembly 20 is attached to one end of the lever arm 14. Furthermore, an electromagnet 24 is disposed adjacent the permanent magnet assembly 20, with the electromagnet 24 having a core 28 with legs 30, 31, and 33. A coil 36 is wound around center leg 33.

A battery/oscillator section 26 is provided next to the electromagnet 24, and includes a battery 38 that provides power to an oscillator 40. The oscillator 40 produces an operating signal having a selected operating frequency in the range of 150-400 Hz, with the operating signal being applied to the coil 36.

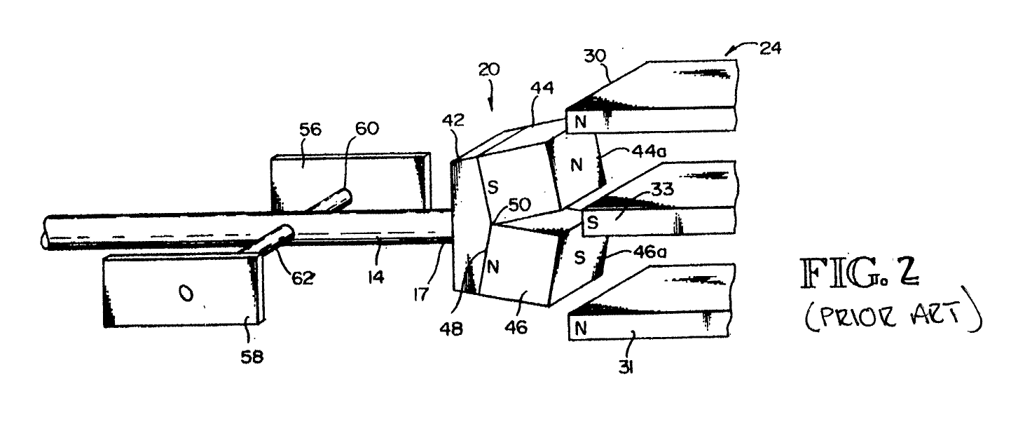

FIG. 2 is a more detailed view of the relationship between the permanent magnet assembly 20 and legs 30, 33 and 31 of the electromagnet 24. In operation, if the driving signal for the electromagnet 24 has a first polarity, upper and lower legs 30 and 31 have north polarities while the center leg 33 has a south polarity. Likewise, during a driving signal of another polarity, the relative polarities of the legs are opposite. In other words, the upper and lower legs 30 and 31 have south polarities while the center leg 33 has a north polarity. The alternating polarity of the three legs 30, 31 and 33 result in retraction and repulsion forces on the permanent magnet elements 44 and 46 of the permanent magnet assembly 20, which creates a torque on the lever arm 14 and vertical, or horizontal, movement of the brush 15.

In other words, Giuliani relies upon the electromagnet having an alternating drive signal to create the vertical or horizontal movement of the permanent magnet.

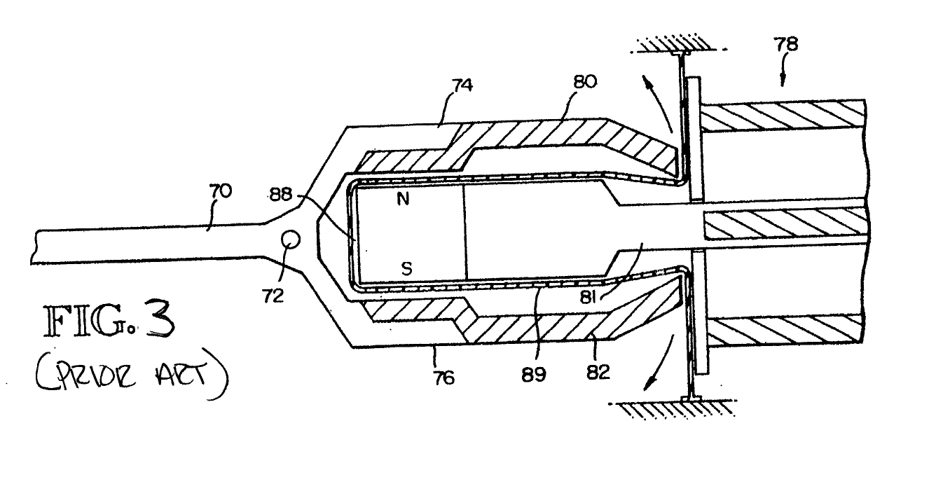

FIG. 3 illustrates another embodiment of the Giuliani vibrating toothbrush wherein bias flux for driving a lever arm 70 is provided by a permanent magnet 88 fixed within the device rather than on the lever arm as in the above-described embodiment.

### SUMMARY OF THE INVENTION

An object of this invention is to provide a vibrating toothbrush having a rotatable motor with a rotatable magnet attached to the motor, the rotatable magnet having a plurality of alternating pairs of magnetic poles. A lever arm having a first end positioned adjacent the rotatable magnet and a second end opposite the first end. A permanent magnet is disposed on the first end of the lever arm, wherein rotation of the motor rotates the rotatable magnet, and a position of the plurality of alternating pairs of magnetic poles changes relative to the permanent magnet. The first end of the lever arm having the permanent magnet thereon oscillates relative to a longitudinal axis of the toothbrush. The rotatable magnet may be disc-shaped. The permanent magnet may be flat and orthogonal relative to the rotatable magnet.

It is another object of this invention to provide a toothbrush also having a power source that provides power to the motor. The power source can be a battery with a charging coil.

It is yet another object of this invention to provide a toothbrush having a brush disposed on the second end of the lever arm, the brush vibrating when the permanent magnet oscillates.

It is further an object of this invention to provide a toothbrush having a hollow case within which the power source, motor, rotatable magnet, and lever arm are disposed. A power and speed adjuster provided on the hollow case and operatively connected to the power source increases and/or decreases an amount of current provided to the motor to adjust a frequency of vibration of the brush.

It is also an object of this invention to provide a toothbrush having a collar disposed intermediate the first and second ends of the lever arm, the collar having a mounting portion that fixedly mounts the lever arm to an interior surface of the hollow case.

It is an object of this invention to provide a vibrating toothbrush having a hollow case, a rotatable motor disposed therein, and a rotatable magnet attached to the motor. The rotatable magnet has a plurality of alternating pairs of magnetic poles. A main stem having a first end positioned adjacent the rotatable magnet and a second end opposite the first end. A permanent magnet is disposed on the first end of the main stem with a biasing member disposed around the main stem. A first end of the biasing member is attached to the permanent magnet and a second end of the biasing member is attached to an inner surface of the case, wherein the motor rotates the rotatable magnet, and a position of the plurality of alternating pairs of magnetic poles changes relative to the permanent magnet. The first end of the main stem having the permanent magnet thereon oscillates relative to a longitudinal axis of the toothbrush and the biasing member dampens the oscillation of the main stem.

It is an object of this invention to provide a toothbrush also having a power source that provides a current to the motor. The power source may be a battery with a charging coil.

It is a further object of this invention to provide a toothbrush having a lever arm including a first end and a second end, the first end of the lever arm being attached to a second end of the main stem and the second end of the lever arm having a brush.

It is yet another object of this invention to provide a toothbrush having a power and speed adjuster provided on the hollow case and operatively connected to the power source to increase and/or decrease an amount of current provided to the motor to adjust a frequency of vibration of the brush.

It is another object of this invention to provide a toothbrush wherein the permanent magnet is disc shaped and arranged on the first end of the lever arm to be parallel relative to the rotatable magnet.

### DETAILED DESCRIPTION OF DRAWINGS

The invention will be described in conjunction with the following drawings in which like reference numerals designate like elements and wherein:

FIG. 1 is a cross section of a conventional vibrating toothbrush;

FIG. 2 is an enlarged view of a permanent magnet assembly of the conventional vibrating toothbrush illustrated in FIG. 1;

FIG. 3 is an enlarged view of another embodiment of a permanent magnet assembly of the conventional vibrating toothbrush shown in FIG. 1;

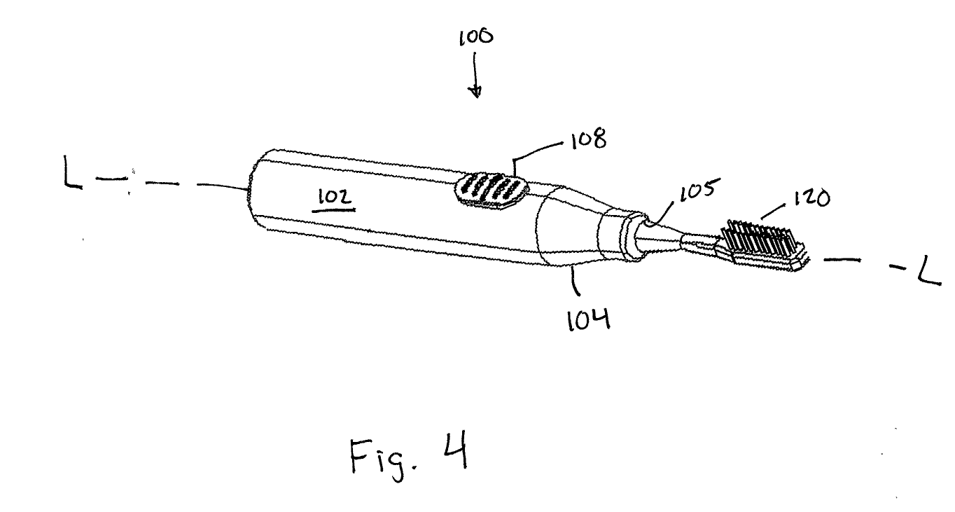

FIG. 4 is a perspective view of the vibrating toothbrush according to a preferred embodiment of this invention with a case attached;

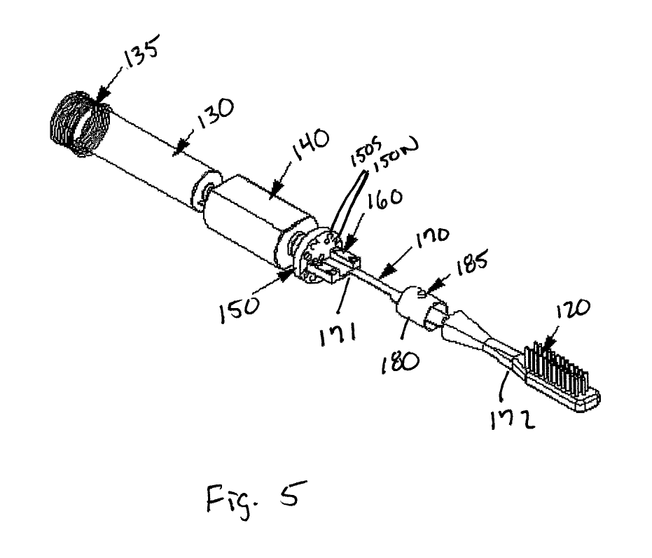

FIG. 5 is a perspective view of the vibrating toothbrush of FIG. 4 with the case removed;

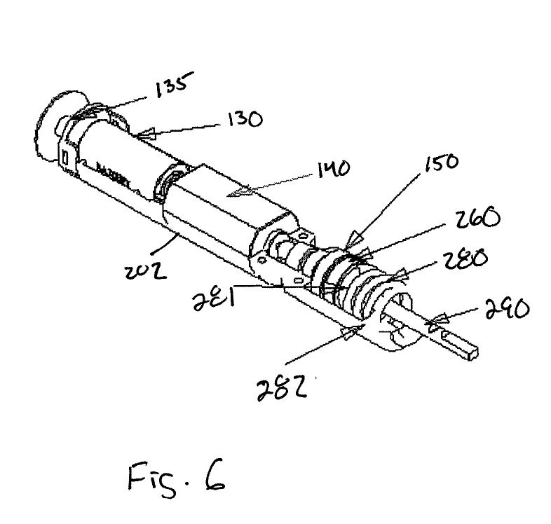

FIG. 6 is a perspective view of the vibrating toothbrush according to another embodiment of this invention with a case partially removed; and

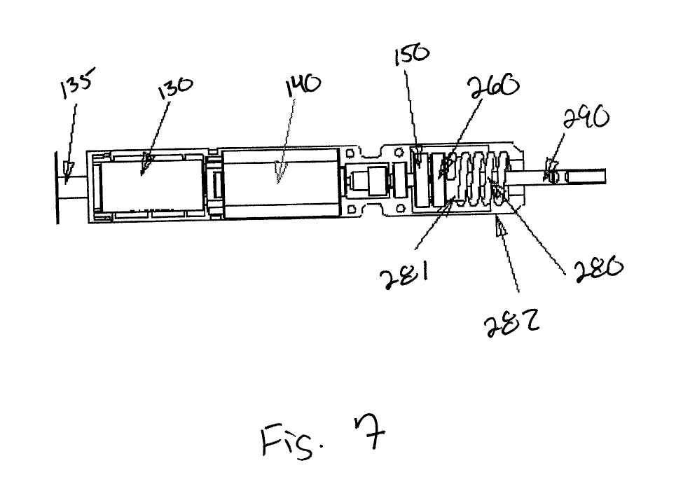

FIG. 7 is a cross sectional view of the vibrating toothbrush of FIG. 6.

### DETAILED DESCRIPTION OF THE INVENTION

FIGS. 4 and 5 show one embodiment of a battery powered, permanent magnetic driven toothbrush according to one example of the invention. The vibrating toothbrush 100 includes a substantially cylindrical elongated hollow case 102 within which other features of the toothbrush are included. The case 102 is illustrated as being circular in cross-section merely for exemplary purposes, but any suitable geometric cross-sectional shape, e.g., square, rectangular, and the like, that will enable a user to easily grip the toothbrush is considered to be within the scope of this invention.

The case 102 includes a tapered portion 104 having a narrowing diameter relative to a longitudinal axis L of the toothbrush 100. A brush 120 extends from an opening 105 of the tapered portion 104 of the case 102. A power and speed adjuster 108 is also provided on an exterior surface of the case 102.

The power and speed adjuster 108 is operatively connected to a power source provided within the case 102. The power and speed adjuster 108 allows a user to manipulate the toothbrush 100 between ON and OFF settings as well as increase and/or decrease the speed or frequency with which brush 120 vibrates in a manner that is well known in the art and will be discussed further below.

Inside the case 102 can be a power source 130, preferably a battery, with a charging coil 135. A motor 140 is adjacent to and powered by the power source 130 with charging coil 135. A magnetic disc 150 is rotatably connected to the motor 140 and has a series of alternating pairs of magnetic poles 150S and 150N.

The magnetic disc 150 is adjacent a relatively flat permanent magnet 160 disposed at a first end 171 of a lever 170. The permanent magnet 160 is orthogonal relative to the magnetic disc 150. The brush 120 is positioned at a second end 172 of the lever 170 with a collar 180 provided intermediate the first and second ends 171 and 172 on the lever 170. The collar 180 includes a mounting portion 185 that fixedly mounts the lever arm 170 to an interior surface of the case 102.

In operation, the power and speed adjuster 108 is initially depressed, thereby closing a circuit so current flows from the power source 130 to the motor 140 in a well known manner. Then, the user may slide the adjuster 108 in a direction parallel to the longitudinal axis L of the toothbrush 100 so as to decrease resistance in the circuit in a well known manner, thereby increasing the flow of current to the motor 140. Because the motor 140 is rotated by the current or power provided from the power source 130 and charging coil 135, increasing or decreasing the flow of current will have a corresponding affect on the rate of rotation of the motor 140. Any known speed control circuitry can be used to control rotational speed.

As the motor 140 rotates, the alternating magnetic poles 150S and 150N of the rotating magnetic disc 150 changes the polarity of the disc 150 relative to the permanent magnetic plate 160 positioned adjacent thereto. The alternating polarity of the disc 150 relative to the permanent magnetic plate 160 results in the oscillation of the first end 171 of the lever 170 about the longitudinal axis L of the toothbrush 100, due to the oscillatory affect of the alternating magnetic fields.

The mounting portion 185 of the collar 180 being fixed to the inner surface of the case 102 results in the brush 120 on the second end 172 of the lever 170 vibrating. The speed or frequency of the brush 120 vibrating can easily be adjusted by changing the rotational speed of the motor 140, which is a result of adjusting the flow of current from the power source 130 to the motor 140.

Because the structural arrangement of this invention does not require an electromagnet, a driving signal is not required to be applied to the magnetic disc. Rather, as described above, the rotation of the motor 140 results in the rotation or alternating polarity of the magnetic disc 150. In other words, the speed or frequency of vibration of the brush 120 is completely variable and based solely on the rotating speed of the motor 140. Furthermore, the structural arrangement of this invention is free of any requisite relationship between the motor 140 and any natural speed or frequency which exists with respect to the lever 170, which thereby allows for a simplified structure and more effective speed or frequency control than the prior art.

FIG. 6 illustrates a second embodiment of the invention with a case 202 partially removed. The second embodiment, like the embodiment discussed above, includes a motor 140 powered by a power source 130 with charging coil 135. Furthermore, the motor 140 rotates the magnetic disc 150 which is adjacent a magnetic disc plate 260. Whereas the flat magnetic plate 160 of the first embodiment was orthogonal to the magnetic disc 150, the magnetic disc plate 260 of this embodiment is parallel to the magnetic disc 150. A biasing member 280, i.e., a spring, supports a main stem 290 attached to the magnetic disc plate 260. The main stem 290 engages a lever arm or brush 120.

FIG. 7 shows a cross-sectional view of the toothbrush shown in FIG. 6. The biasing member 280 has a first end 281 connected to the permanent magnetic disc plate 260 and a second end 282 connected to an interior surface of the case 102 near the tapered portion 104 thereof.

The second embodiment operates similar to the first embodiment described above. As the motor 140 rotates, the alternating magnetic poles 150S and 150N the rotating magnetic disc 150 changes the polarity of the disc 150 relative to the permanent magnetic plate 260 positioned adjacent and parallel thereto. The alternating polarity of the disc 150 relative to the permanent magnetic plate 260 results in the oscillation of the main stem 290 due to the oscillatory affect of the alternating magnetic fields.

Because the mounting portion 185 of the collar 180 (FIG. 5) are fixed to the inner surface of the case 102, the brush 120 attached to the end of the main stem 290 vibrates. As in the first embodiment, the speed or frequency of the brush 120 vibrating can easily be adjusted by changing the rotational speed of the motor 140, which is a result of adjusting the flow of current from the power source 130 to the motor 140.

While the invention has been described in conjunction with specific exemplary embodiments outlined above, it is evident that many alternatives, modifications and variations may be apparent to those skilled in the art.

Accordingly, the preferred embodiments of the invention as set forth herein are intended to be illustrative, not limiting. Various changes may be made without departing from the spirit and scope of this invention.

What is claimed is:

1. A vibrating toothbrush, comprising:
a rotatable motor;
a rotatable magnet attached to the motor, the rotatable magnet having a plurality of alternating pairs of magnetic poles; and
a lever arm having a first end positioned adjacent the rotatable magnet and a second end opposite the first end, wherein a permanent magnet is disposed on the first end of the lever arm,
wherein rotation of the motor rotates the rotatable magnet, and a position of the plurality of alternating pairs of magnetic poles changes relative to the permanent magnet,
wherein the first end of the lever arm having the permanent magnet thereon oscillates relative to a longitudinal axis of the toothbrush.

2. The toothbrush according to claim 1, further comprising a power source that provides power to the motor.

3. The toothbrush according to claim 1, further comprising a brush disposed on the second end of the lever arm, the brush vibrating when the permanent magnet oscillates.

4. The toothbrush according to claim 3, further comprising:
a hollow case within which the power source, motor, rotatable magnet, and lever arm are disposed; and
a power and speed adjuster provided on the hollow case and operatively connected to the power source to increase and/or decrease an amount of current provided to the motor to adjust a frequency of vibration of the brush.

5. The toothbrush according to claim 2, wherein the power source comprises a battery with a charging coil.

6. The toothbrush according to claim 1, wherein the rotatable magnet is disc shaped.

7. The toothbrush according to claim 1, wherein the permanent magnet is flat and arranged on the first end of the lever arm to be orthogonal relative to the rotatable magnet.

8. The toothbrush according to claim 4, wherein the lever arm further comprises a collar disposed intermediate the first and second ends of the lever arm, the collar having a mounting portion that fixedly mounts the lever arm to an interior surface of the hollow case.

9. A vibrating toothbrush, comprising:
a hollow case;
a rotatable motor;
a rotatable magnet attached to the motor, the rotatable magnet having a plurality of alternating pairs of magnetic poles;
a main stem having a first end positioned adjacent the rotatable magnet and a second end opposite the first end, wherein a permanent magnet is disposed on the first end of the main stem; and
a biasing member disposed around the main stem, a first end of the biasing member being attached to the permanent magnet and a second end of the biasing member being attached to an inner surface of the case,
wherein the motor rotates the rotatable magnet, and a position of the plurality of alternating pairs of magnetic poles changes relative to the permanent magnet,
wherein the first end of the main stem having the permanent magnet thereon oscillates relative to a longitudinal axis of the toothbrush and the biasing member dampens the oscillation of the main stem.

10. The toothbrush according to claim 9, further comprising a power source that provides a current to the motor.

11. The toothbrush according to claim 9, further comprising a lever arm having a first end and a second end, the first end of the lever arm being attached to a second end of the main stem and the second end of the lever arm having a brush.

12. The toothbrush according to claim 10, further comprising a power and speed adjuster provided on the hollow case and operatively connected to the power source to increase and/or decrease an amount of current provided to the motor to adjust a frequency of vibration of the brush.

13. The toothbrush according to claim 10, wherein the power source comprises a battery with a charging coil.

14. The toothbrush according to claim 9, wherein the rotatable magnet is disc shaped.

15. The toothbrush according to claim 9, wherein the permanent magnet is disc shaped and arranged on the first end of the lever arm to be parallel relative to the rotatable magnet.

16. A vibrating toothbrush having a power source that provides a current to a rotatable motor, the toothbrush comprising:
a rotatable magnet attached to the motor, the rotatable magnet having a plurality of alternating pairs of magnetic poles; and
a lever arm having a first end positioned adjacent the rotatable magnet and a second end opposite the first end, wherein a permanent magnet is disposed on the first end of the lever arm,
wherein rotation of the motor rotates the rotatable magnet, and a position of the plurality of alternating pairs of magnetic poles changes relative to the permanent magnet,
wherein the first end of the lever arm having the permanent magnet thereon oscillates relative to a longitudinal axis of the toothbrush.

17. The toothbrush according to claim 16, further comprising a power source that provides power to the motor.

18. The toothbrush according to claim 16, further comprising a brush disposed on the second end of the lever arm, the brush vibrating when the permanent magnet oscillates.

19. The toothbrush according to claim 18, further comprising:
a hollow case within which the power source, motor, rotatable magnet, and lever arm are disposed; and
a power and speed adjuster provided on the hollow case and operatively connected to the power source to increase and/or decrease an amount of current provided to the motor to adjust a frequency of vibration of the brush.

20. The toothbrush according to claim 17, wherein the power source comprises a battery with a charging coil.

21. The toothbrush according to claim 16, wherein the rotatable magnet is disc shaped.

22. The toothbrush according to claim 16, wherein the permanent magnet is flat and arranged on the first end of the lever arm to be orthogonal relative to the rotatable magnet.

23. The toothbrush according to claim 19, wherein the lever arm further comprises a collar disposed intermediate the first and second ends of the lever arm, the collar having a mounting portion that fixedly mounts the lever arm to an interior surface of the hollow case.
